(19) United States
(12) Patent Application Publication
(10) Pub. No.: US 2025/0306827 A1
(43) Pub. Date: Oct. 2, 2025

(54) INFORMATION PROCESSING DEVICE SETTING PRINTING ORDER FOR PRINT DATA TO BE TRANSMITTED TO PRINTER ACCORDING TO SUPPORT PROGRAM

(71) Applicant: BROTHER KOGYO KABUSHIKI KAISHA, Nagoya (JP)

(72) Inventors: Kenju NARITA, Nagoya (JP); Airi EGUCHI, Ichinomiya (JP); Yoshito HOSOMIZO, Konan (JP)

(21) Appl. No.: 19/040,027

(22) Filed: Jan. 29, 2025

(30) Foreign Application Priority Data
Mar. 27, 2024 (JP) 2024-050895

(51) Int. Cl. G06F 3/12

(52) U.S. Cl. CPC G06F 3/1263; G06F 3/1212; G06F 3/1253

(57) ABSTRACT

A non-transitory computer-readable storage medium stores a support program for an information processing device communicable with a printer. The support program corresponds to the printer. The support program, when executed by a computer of the information processing device, causes the information processing device to perform, when a printing target corresponding to a print instruction includes a plurality of target images corresponding to respective ones of a plurality of pages: controlling a printing order of the plurality of target images for acquiring print data to be transmitted to the printer. The controlling includes: when a print setting corresponding to the print instruction includes a setting specifying duplex printing, setting the printing order for the print data to a normal order; and when the print setting corresponding to the print instruction does not include the setting specifying the duplex printing, setting the printing order for the print data to a reverse order.

### REFERENCE TO RELATED APPLICATIONS

This application claims priority from Japanese Patent Application No. 2024-050895 filed on Mar. 27, 2024. The entire content of the priority application is incorporated herein by reference.

### BACKGROUND ART

In recent years, practical technologies have been developed for controlling printers without the use of a printer driver provided by a printer vendor. One such technology utilizes a general-purpose printing program as a part of the operating system (OS) as standard. With this technology, the OS, upon detecting a printer, associates the printer with the OS-standard general-purpose printing program. Thereafter, when a print instruction to that printer is received, the OS-standard general-purpose printing program generates print data without the need for a printer driver provided a vendor of that printer, and thus can control printing based on the print data.

Japanese Patent Application Publication No. 2021-056642 discloses a support program for supporting a general-purpose printing program. When duplex printing is to be performed, the support program is configured to execute processes on the intermediate data received from the general-purpose printing program, including a rotation process to rotate the image of each page requiring rotation by 180 degrees, and a reordering process to rearrange the processing order from a page order to a printing order.

### SUMMARY

While Japanese Patent Application Publication No. 2021-056642 describes a technique for combining image rotation with a rearrangement of the printing order when performing duplex printing, a new technique for setting the printing order is needed for cases in which printing instructions are provided to a general-purpose printing program.

In order to attain the above and other objects, the present disclosure provides a non-transitory computer-readable storage medium storing a support program for an information processing device communicable with a printer. An operating system of the information processing device includes a general-purpose printing program. The support program corresponds to the printer and supports the general-purpose printing program. The printer has: a single-sided printing function for performing single-sided printing; and a duplex printing function for performing duplex printing. The printer includes a conveying mechanism. The conveying mechanism is configured to convey a sheet having a first surface and a second surface opposite the first surface. The conveying mechanism is configured to, when the printer performs the single-sided printing in which printing is performed on the first surface of the sheet, discharge the sheet with the first surface facing upward. The conveying mechanism is configured to, when the printer performs the duplex printing in which printing is first performed on the first surface of the sheet and subsequently performed on the second surface of the sheet, discharge the sheet with the first surface facing downward and the second surface facing upward. The support program, when executed by a computer of the information processing device, causes the information processing device to perform: when a print instruction to have the printer execute printing of a target image for a printing target is issued from an application program implemented in the information processing device to the general-purpose printing program: (a) acquiring; and (b) executing. The (a) acquiring acquires intermediate data from the general-purpose printing program. The intermediate data represents the target image for the printing target corresponding to the print instruction. The (b) executing executes a process for having the printer execute printing based on print data corresponding to the intermediate data acquired in the (a) acquiring. The support program, when executed by the computer, causes the information processing device to further perform, when the printing target corresponding to the print instruction includes a plurality of target images corresponding to respective ones of a plurality of pages: (c) controlling. The (c) controlling controls a printing order of the plurality of target images for acquiring the print data to be transmitted to the printer. The (c) controlling including: when a print setting corresponding to the print instruction includes a setting specifying the duplex printing, (c-1) setting; and when the print setting corresponding to the print instruction does not include the setting specifying the duplex printing, (c-2) setting. The (c-1) setting sets the printing order for the print data to a normal order. The normal order is same as a page order in which the plurality of target images a rearranged in the printing target. The (c-2) setting sets the printing order for the print data to a reverse order. The reverse order is opposite the normal order.

According to the technique disclosed in this specification in which a printer has a conveying mechanism that discharges sheets with printed surfaces facing upward, when single-sided printing, rather than duplex printing, is specified, the printing order for print data to be transmitted to the printer is set to a reverse order opposite the page order so that the printer outputs a set of printed matter into a discharge tray with pages arranged in order from top to bottom. This method eliminates the need for the user to rearrange the printed sheets and outputs the printed matter in a manner that is less likely to stain the user's hand with colorant. When duplex printing is specified, on the other hand, both surfaces of the sheets are printed surfaces and neither surface is given priority for the drying of colorant. Hence, the printing order for print data to be transmitted to the printer is kept in a normal order same as the page order, eliminating the process of reversing the page order, which will likely enable the printing process to begin sooner.

According to the technique disclosed in this specification, a new technique for setting a printing order is provided for an information processing device on which an OS-standard general-purpose printing program is installed.

### BRIEF DESCRIPTION OF DRAWINGS

FIG. 1 is a block diagram schematically illustrating an electrical configuration of a personal computer.

FIG. 2 is a sequence chart illustrating an example of a printing execution procedure.

FIG. 3 is an explanatory diagram illustrating an example of a print settings screen.

FIGS. 4A through 4C are explanatory diagrams illustrating methods of processing data.

FIG. 5 is a sequence chart illustrating another example of the printing execution procedure.

FIG. 6 is a sequence chart illustrating still another example of the printing execution procedure.

FIG. 7 is a sequence chart illustrating still another example of the printing execution procedure.

### DESCRIPTION

### First Embodiment

Below, a personal computer (hereinafter referred to as “PC”) using a support program according to one embodiment will be described while referring to the accompanying drawings. This specification describes the support program executed on the PC. Note that the support program can be run on smartphones and mobile devices, as well as PCs.

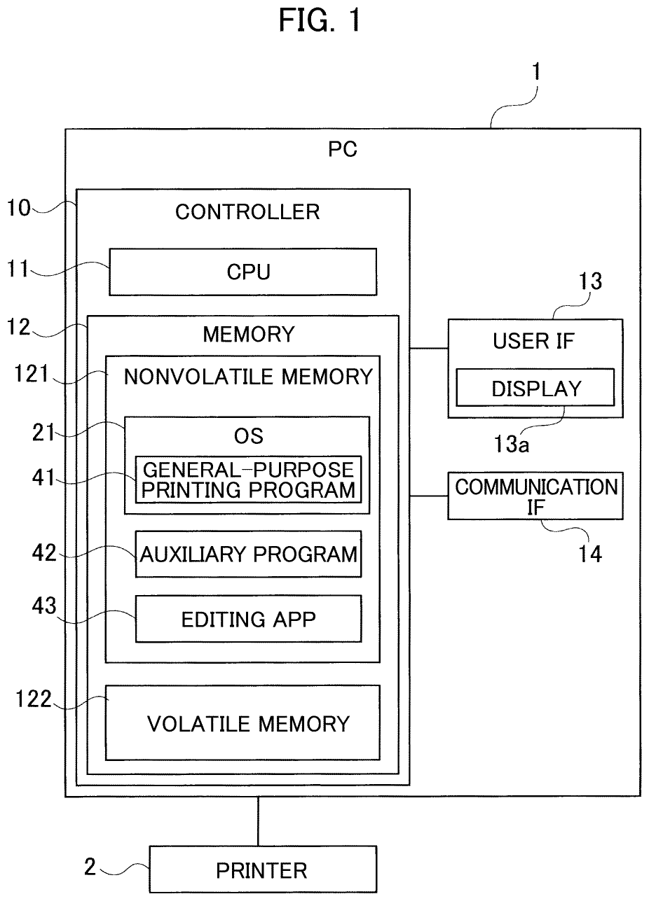

As illustrated in FIG. 1, the PC 1 of the present embodiment includes a controller 10 that includes a CPU 11 and a memory 12. The PC 1 is an example of the information processing device of the present disclosure. The CPU 11 is an example of the computer of the present disclosure. The PC 1 also includes a user interface (also described as “user IF”) 13 and a communication interface (also described as “communication IF”) 14, both of which are electrically connected to the controller 10. Note that the controller 10 in FIG. 1 is a general concept that covers all hardware and software used for controlling the PC 1 and is not actually limited to representing a single piece of hardware present in the PC 1.

The CPU 11 of the PC 1 executes various processes according to programs read from the memory 12 or based on user operations. The memory 12 includes nonvolatile memory 121 and volatile memory 122. The volatile memory 122 is used as a work area for executing various programs, for example. A buffer provided in the CPU 11 is also one example of the memory 12. Examples of the memory 12 may be a ROM, a RAM, a hard disk drive, or the like built into the PC 1 or may be any storage medium that is readable and writable by the CPU 11, such as a CD-ROM, a DVD-ROM, or other storage media.

The user interface 13 includes hardware that displays screens for reporting information to the user, and specifically a display 13a, and hardware that receives user operations. The user interface 13 may be a set of devices that includes the display 13a for displaying information, and a mouse, keyboard, and the like having input-receiving functions. Alternatively, the user interface 13 may be a touchscreen having both the function of the display 13a and an input-receiving function. The user interface 13 is an example of the user interface of the present disclosure.

The communication interface 14 includes hardware for communicating with external devices such as a printer 2. The communication standard employed by the communication interface 14 may be Ethernet (registered trademark), Wi-Fi (registered trademark), Universal Serial Bus (USB), or the like. “Ethernet” is a Japanese registered trademark of FUJIFILM Business Innovation Corp. “Wi-Fi” is a registered trademark of Wi-Fi Alliance. The PC 1 may be capable of connecting to the Internet via the communication interface 14. Alternatively, the PC 1 may include a plurality of communication interfaces 14 supporting a plurality of communication standards.

As illustrated in FIG. 1, the nonvolatile memory 121 of the memory 12 stores various programs and various data including an operating system (hereinafter referred to as “OS”) 21, an auxiliary program 42, and an editing application program (hereinafter referred to as “editing app”) 43. The OS 21 includes a general-purpose printing program (general-purpose printing program, or generic program) 41. The auxiliary program 42 is an example of the support program of the present disclosure.

The OS 21 is a multitasking OS capable of concurrently processing a plurality of tasks by managing and switching between the tasks. The OS 21 is one of Windows (registered trademark), macOS (registered trademark), Linux (registered trademark), iOS (registered trademark), and Android (registered trademark), for example. “Windows” is a registered trademark of Microsoft Corporation. “macOS” is a registered trademark of Apple Inc. “Linux” is a registered trademark of Linus Torvalds. “iOS” is a registered trademark of Cisco Technology Inc. “Android” is a registered trademark of Google LLC.

The general-purpose printing program 41 is implemented (or embedded) in the OS 21. The general-purpose printing program 41 is an OS-standard program prepared by the vendor of the OS 21 and provided as part of the OS 21. In other words, the OS 21 having the general-purpose printing program 41 is installed on the PC 1. The general-purpose printing program 41 is not configured to use printer drivers specific to individual printers.

The general-purpose printing program 41 functions to execute printing on a plurality of models of printers (printer models) respectively provided by a plurality of vendors on the basis of user commands. The general-purpose printing program 41 supports generic functions that allow printing to be executed on many printers. Unlike printer drivers designed for specific types of printers 2, the general-purpose printing program 41 does not support functions that are specific to each printer 2 or printer driver, particularly those functions that require complex processing.

The general-purpose printing program 41 includes functions for receiving image data specified as the printing target in print instructions outputted or issued from various application programs (also described as “app(s)”) based on user commands and for generating intermediate data based on that image data. An example of intermediate data is XML Paper Specification (XPS) data. XML is an abbreviation of Extensible Markup Language. The general-purpose printing program 41 also has a function for generating print data based on intermediate data in a format that can be used for printing on various printers. An example of print data is PWG Raster data or PDF data. PWG is an abbreviation of Printer Working Group, and PDF is an abbreviation of Portable Document Format. The general-purpose printing program 41 also has a function for transmitting the generated print data to a printer 2 designated as the device for executing printing via a communication function of the OS 21.

The auxiliary program 42 is a program or a set of programs that execute processes based on instructions from the OS 21 in conjunction with the processes of the general-purpose printing program 41 and is a program that provides control support for the target hardware. The auxiliary program 42 of the present embodiment supports the printer model of the printer 2 connected to the PC 1 and is provided by the vendor of the printer 2, for example. That is, the auxiliary program 42 corresponds to and is designed for the printer model of the printer 2.

The general-purpose printing program 41 starts up the auxiliary program 42 corresponding to the printer 2 in the following cases including: when the printer 2 is selected as the device to execute printing; when an instruction or a command for advanced print settings is received while the printer 2 is selected; when an instruction or a command to execute printing on the printer 2 is received; and the like. To start up the auxiliary program 42, the general-purpose printing program 41 or the OS 21 may issue a start-up instruction to start up the auxiliary program 42. The auxiliary program 42 is called a Print Support Application (PSA) Program or a Hardware Support Application (HSA) Program, for example.

The auxiliary program 42 may be a combination of a plurality of programs, each of which receives execution instructions, or may be a single program that can execute different processes according to the received instructions. The vendors of printers may prepare an auxiliary program for each type of printer. For example, one auxiliary program may be prepared for inkjet printers and another auxiliary program may be prepared for laser printers. Alternatively, an auxiliary program may be prepared for each printer model or model series rather than each type of printer 2.

When a new printer is connected to the PC 1, for example, the OS 21 of the PC 1 can download the appropriate auxiliary program from a server of the vendor of the printer 2 or the like based on the type or printer model of the connected printer and can install this program on the PC 1. The OS 21 stores identification information for the installed auxiliary program in the memory 12 in association with printer information on the newly connected printer.

The editing app 43 is a program used for creating and editing image data and document data, for example. Examples of the editing app 43 include Microsoft Word and Microsoft PowerPoint (registered trademark) developed by Microsoft Corporation (registered trademark), and a program provided by the vendor of the printer 2. “Microsoft” and “PowerPoint” are registered trademarks of Microsoft Corporation. The editing app 43 accepts commands via the user interface 13, such as a print execution command for instructing the printer 2 to execute printing. The editing app 43 is not limited to a program for creating and editing data but may be a program that accepts print execution commands and display commands for displaying various types of information, such as map information and web pages, in response to user requests.

As illustrated in FIG. 1, the PC 1 of the present embodiment is connected to the printer 2 via the communication interface 14. The printer 2 is an inkjet printer and a device that possesses at least a print function and a communication function. When print data is received from the PC 1 or the like, for example, the printer 2 can execute printing based on the received print data. The printer 2 may be capable of performing color printing or may only be capable of performing monochrome printing.

The printer 2 also has a single-sided printing function, and a duplex printing function for automatically printing on both front and back sides (surfaces) of sheets using a single-sheet conveying method. As an example, the printer 2 is provided with a printing unit (not illustrated) disposed above a conveying path, and a sheet-conveying mechanism (not illustrated) configured to discharge sheets printed by the printing unit so that, in the case of single-sided printing, the printed surface of the sheet discharged into a discharge tray (not illustrated) faces upward.

In the case of duplex printing, the sheet-conveying mechanism described above is configured to convey a sheet according to the following procedure. First, a sheet fed from a paper tray (not illustrated) is conveyed along the conveying path as the printing unit prints an image on a first surface of the sheet. Next, the sheet-conveying mechanism reverses the conveying direction of the sheet before the sheet having been printed on the first surface is discharged into the discharge tray. The reversed sheet is then conveyed back to the printing unit as the printing unit prints an image on a second surface of the sheet opposite the first surface. The sheet-conveying mechanism subsequently discharges the sheet printed on the second surface into the discharge tray with the second surface facing upward. Here, by reversing the conveying direction of the sheet, the leading edge of the sheet when the first surface is printed becomes the trailing edge of the sheet when the second surface is printed. Therefore, an image corresponding to print data to be printed on the second surface of the sheet opposite the first surface is rotated 180 degrees from an image corresponding to print data to be printed on the first surface of the sheet. Furthermore, since the sheet is discharged with the printed surface facing upward, the first surface printed first faces downward and the second surface printed subsequently faces upward when the sheet is discharged into the discharge tray.

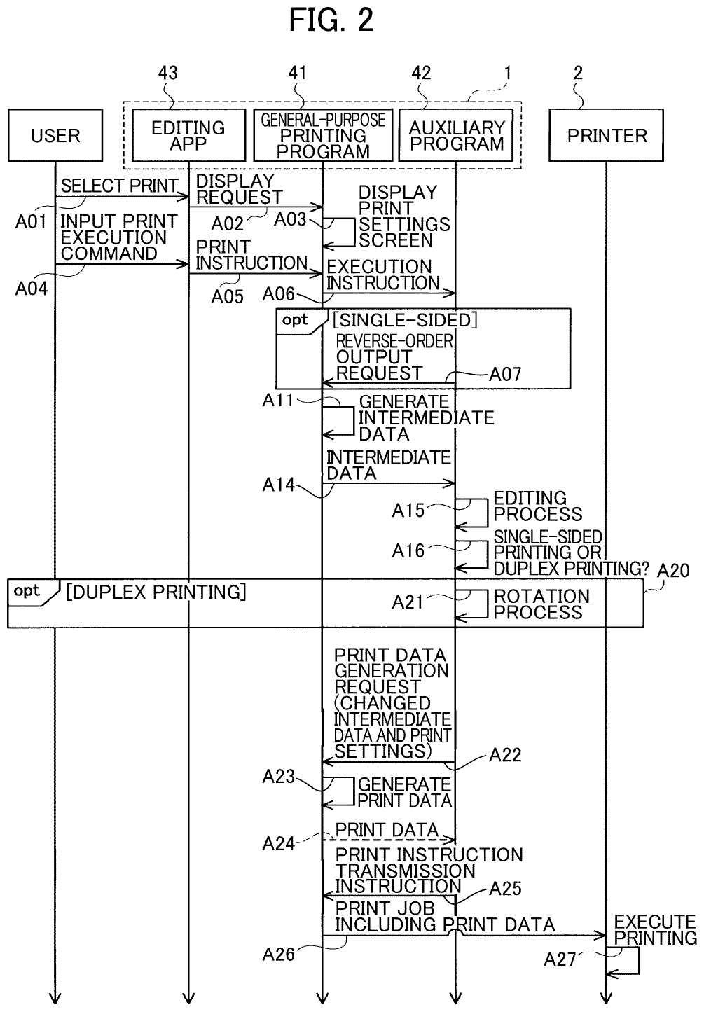

Next, steps in a printing process performed on the PC 1 of the present embodiment when printing is executed using the printer 2 will be described with reference to the sequence chart illustrated in FIG. 2. All processes other than user operations in this embodiment essentially indicate processes performed by the CPU 11 according to instructions described in the auxiliary program 42 and other programs.

While the controller 10 or CPU 11 performs the various processes according to such programs as the auxiliary program 42, general-purpose printing program 41, and OS 21, the processes may be described in this specification as if they are being executed by the programs themselves. Processes performed by the CPU 11 include hardware control using the API in the OS 21. However, a detailed description of the role of the OS 21 is omitted in this specification when describing operations of the programs.

First, prior to printing using the printer 2, user can create and edit text and images using the editing app 43. When the user wishes to print the displayed text and images, in A01 the user selects “PRINT” in the editing app 43. For example, the user can select a print option from a menu of operations provided in the editing app 43.

Upon receiving a selection of “PRINT,” in A02 the editing app 43 issues a request to the general-purpose printing program 41 of the OS 21 to display a screen that accepts printing-related instructions. In response to this request, in A03 the general-purpose printing program 41 displays a print settings screen on the user interface 13. The print settings screen accepts user instructions for various print settings supported by the general-purpose printing program 41. As an alternative, the editing app 43 may display the print settings screen.

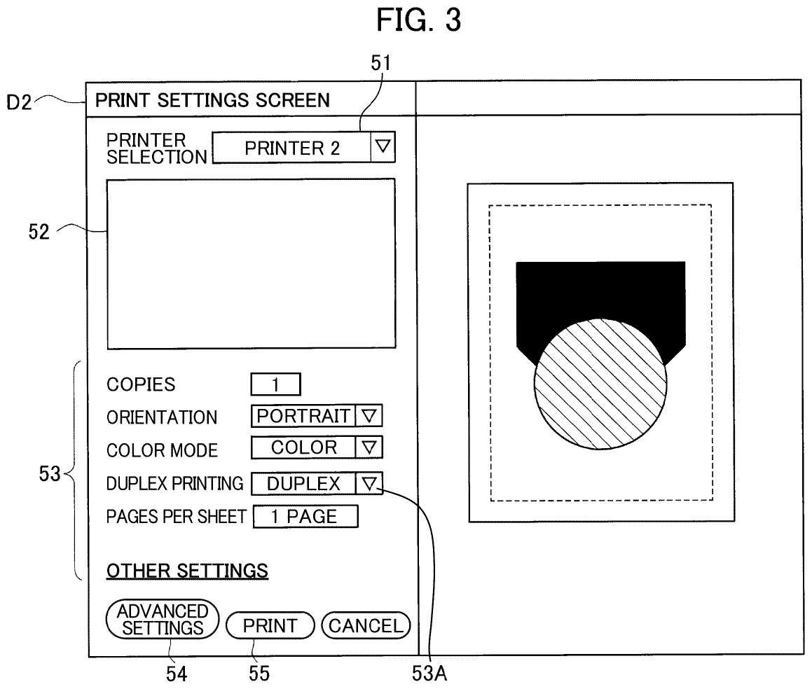

FIG. 3 illustrates an example of a print settings screen D2. The print settings screen D2 illustrated in FIG. 3 includes a printer selection field 51, an information display area 52, a print settings area 53 for selecting basic print settings, an ADVANCED SETTINGS button 54, a PRINT button 55, and the like. The printer selection field 51 accepts a user selection for a device to execute printing. The information display area 52 displays information specified by an auxiliary program corresponding to the device selected in the printer selection field 51. For example, when the printer 2 has been selected in the printer selection field 51 or when a print instruction is received in a state where the printer 2 is set in the OS 21 as the default printer, the general-purpose printing program 41 can start up the auxiliary program 42 corresponding to the printer 2 and display an image prepared by the auxiliary program 42 in the information display area 52.

The print settings area 53 for basic print settings accepts such basic settings as the number of copies to be printed and the orientation of the document. The basic print settings area 53 also has a duplex printing selection field 53A that accepts an instruction to perform either single-sided printing or duplex printing. The ADVANCED SETTINGS button 54 accepts an instruction to perform advanced settings not included in the basic print settings area 53. The PRINT button 55 accepts a print execution command using the currently selected print settings.

Returning to the sequence chart in FIG. 2, after the user has selected the image to be printed (printing target image) and configured the print settings for the printer 2, in A04 the user inputs a command in the editing app 43 to execute printing (print execution command). For example, when an operation on the PRINT button 55 is received in the print settings screen D2 illustrated in FIG. 3, the editing app 43 determines that the general-purpose printing program 41 has received a print execution command to print the selected image on the printer 2 since the general-purpose printing program 41 is embedded in the OS 21 of the PC 1.

In A05 the editing app 43 transmits a print instruction to the general-purpose printing program 41 by outputting information on the received print execution command to the general-purpose printing program 41, and the general-purpose printing program 41 acquires this information from the editing app 43. Information on the print execution command includes image data representing the printing target image, and information specifying the print settings.

When a print instruction for the printer 2 is acquired from the editing app 43, in A06 the general-purpose printing program 41 starts up the auxiliary program 42 that corresponds to and supports the designated printer 2 by outputting an execution instruction to the auxiliary program 42. Once started up, the auxiliary program 42 acquires the print settings corresponding to the print instruction. To acquire print settings, the auxiliary program 42 may extract print settings included with the execution instruction received in A06 or may request the print settings from the general-purpose printing program 41 after being started up.

Here, when single-sided printing has been set in the print settings acquired from the general-purpose printing program 41, in A07 the auxiliary program 42 issues a request to the general-purpose printing program 41 to output the intermediate data in reverse order (reverse-order output request). If duplex printing has been set in the print settings, the auxiliary program 42 may request that the intermediate data be outputted in the normal order, or may simply not issue a request regarding the output order when the default setting of the general-purpose printing program 41 is the normal order, provided that there is no request regarding the output order. Subsequently, the auxiliary program 42 completes processing related to the execution instruction received in A06. The process of A07 is an example of the (c) controlling of the present disclosure, and an example of the (c-3) executing of the present disclosure.

After the auxiliary program 42 has completed processing for the execution instruction received in A06, in A11 the general-purpose printing program 41 generates intermediate data from the image data representing the printing target image on the basis of the information acquired from the editing app 43. At this time, when reverse-order output has been set in the general-purpose printing program 41 on the basis of a reverse-order output request received from the auxiliary program 42, the general-purpose printing program 41 generates the intermediate data by arranging (reordering) the pages in reverse order. The setting for reverse-order output in the general-purpose printing program 41 is disabled when duplex printing is set in the print settings. The setting for reverse order output may also be disabled in response to a notification from the auxiliary program 42.

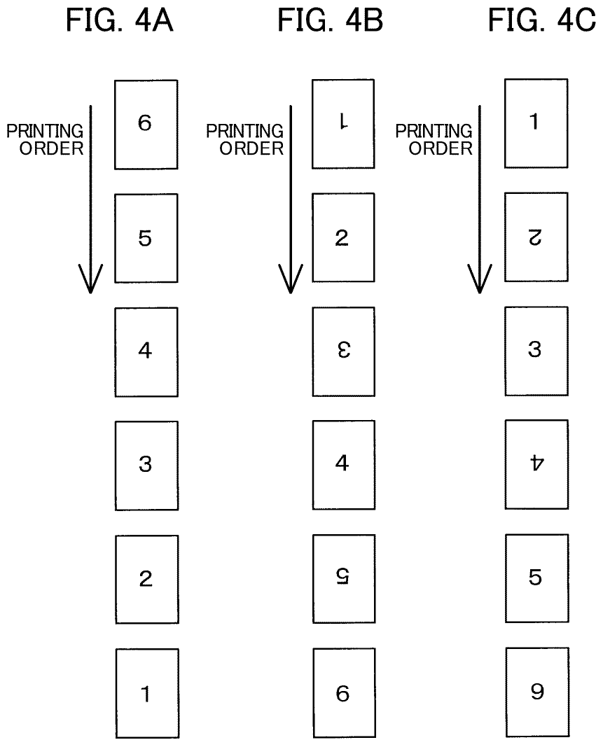

Here, the reordering of pages will be described in greater detail. When the intermediate data is configured of six pages, as illustrated in the example of FIG. 4A, the general-purpose printing program 41 generates intermediate data by rearranging (reordering) the processing order “page 1, page 2, . . . , page 5, page 6” defined by the page order of the intermediate data to “page 6, page 5, . . . , page 2, page 1” corresponding to the printing order in the single-sheet conveying method described above.

On the other hand, when information indicating that a reverse-order output request has been issued is not stored, the general-purpose printing program 41 generates intermediate data in the normal order. In other words, the general-purpose printing program 41 generates intermediate data in the processing order “page 1, page 2, . . . , page 5, page 6,” as defined by the page order of the intermediate data.

Since the editing app 43 contains image data of various types, the general-purpose printing program 41 converts the image data representing the printing target image to intermediate data that is suitable for generating print data. When the image data representing the printing target image is already suitable for generating print data, the general-purpose printing program 41 may skip the process to generate intermediate data and use the image data received from the editing app 43 as the intermediate data.

The general-purpose printing program 41 may also be able to start up the auxiliary program 42 before a print instruction is acquired from the editing app 43 and have the auxiliary program 42 acquire the setting for single-sided printing or duplex printing. For example, the setting for single-sided printing or duplex printing can be accepted in the print settings screen D2. If the general-purpose printing program 41 can start up the auxiliary program 42 when a setting for single-sided printing is received before receiving a print instruction from the editing app 43, the auxiliary program 42 that has been started up may request the general-purpose printing program 41 to output the intermediate data in reverse order (reverse-order output request), and the general-purpose printing program 41 may store information indicating that the reverse-order output request has been issued. When a print instruction is subsequently received from the editing app 43, the general-purpose printing program 41 may generate intermediate data in reverse order based on the stored information.

For example, when the ADVANCED SETTINGS button 54 is operated in the print settings screen D2, the general-purpose printing program 41 starts up the auxiliary program 42 corresponding to the designated printer 2 by outputting an execution instruction to the auxiliary program 42, and the auxiliary program 42 displays an advanced settings screen (not illustrated) for accepting detailed print settings. In this advanced settings screen, the auxiliary program 42 can accept a setting for single-sided printing or duplex printing. When the auxiliary program 42 receives a setting for single-sided printing prior to acquiring a print instruction issued from the editing app 43, the auxiliary program 42 can issue a reverse-order output request to the general-purpose printing program 41 at that timing to output the intermediate data in reverse order, and the general-purpose printing program 41 may store information indicating that the reverse-order output request has been issued. When a print instruction is subsequently issued from the editing app 43, the general-purpose printing program 41 may generate intermediate data in reverse order based on the stored information.

Thus, when performing single-sided printing in the present embodiment, the auxiliary program 42 acquires intermediate data from the general-purpose printing program 41 in reverse page order. Since the print data generated by the auxiliary program 42 is also in reverse page order, as will be described later, the auxiliary program 42 need not rearrange (reorder) the printing order, which can reduce the processing load on the auxiliary program 42.

After the general-purpose printing program 41 generates the intermediate data, in A14 the auxiliary program 42 acquires this intermediate data and the print settings from the general-purpose printing program 41.

When the user has selected duplex printing in the duplex printing selection field 53A of the print settings screen D2 at this time, the general-purpose printing program 41 passes intermediate data to the auxiliary program 42 in the normal order, i.e., in the processing order “page 1, page 2, . . . , page 5, page 6” defined by the page order of the intermediate data.

On the other hand, when the user has selected single-sided printing in the duplex printing selection field 53A of the print settings screen D2 at this time, the general-purpose printing program 41 passes intermediate data to the auxiliary program 42 in reverse order, i.e., the order “page 6, page 5, . . . , page 2, page 1,” which is opposite the processing order defined by the page order of the intermediate data.

In A15 the auxiliary program 42 performs an editing process to edit the intermediate data based on the acquired print settings if necessary. For example, the auxiliary program 42 may add prescribed images or text to the header or footer or combine the image being printed with a watermark image in accordance with the print settings. When 2-in-1 consolidated printing has been set, for example, the auxiliary program 42 edits the intermediate data to reduce the images for two pages and arrange the reduced images for printing on a single sheet. In this case, the order in which pages are arranged on one sheet is right to left for single-sided printing and left to right for duplex printing. In A16 the auxiliary program 42 then determines whether single-sided printing or duplex printing is specified on the basis of the acquired print settings.

When the auxiliary program 42 determines that duplex printing has been set (option A20), in A21 the auxiliary program 42 performs a rotation process on the intermediate data edited in A15.

Here, a specific example of the rotation process will be described. When the intermediate data is configured of six pages, as illustrated in the example of FIG. 4B, the auxiliary program 42 edits the intermediate data in the processing order “page 1, page 2, . . . page 5, page 6” defined by the page order of the intermediate data to rotate the intermediate data for odd-numbered pages 180 degrees based on the printing order in the single-sheet conveying method described above. Alternatively, the target of rotation may be the intermediate data for even-numbered pages, as illustrated in the example of FIG. 4C.

Next, in A22 the auxiliary program 42 passes the print settings and intermediate data to the general-purpose printing program 41 and issues a request to the general-purpose printing program 41 to generate print data (print data generation request). As a result, in A23 the general-purpose printing program 41 rasterizes the intermediate data to generate print data containing raster data, which is bitmap data. In A24 the general-purpose printing program 41 passes the generated print data to the auxiliary program 42.

In A25 the auxiliary program 42 sends an instruction to the general-purpose printing program 41 to transmit a print instruction to the printer 2 by passing the print data to the general-purpose printing program 41 (print instruction transmission instruction). In A26 the general-purpose printing program 41 transmits a print job including the print data to the printer 2. In A27 the printer 2 executes printing based on the print data received from the general-purpose printing program 41, thereby producing printed matter based on the print instruction outputted from the editing app 43.

As a result, when the user has selected single-sided printing in the duplex printing selection field 53A of the print settings screen D2, printed matter, and specifically sheets printed by the printing unit, is discharged into the discharge tray with the printed surfaces facing upward in the order “page 6, page 5, . . . , page 2, page 1.”

Since printers that perform printing according to the inkjet method preferably discharge sheets with the printed surface facing upward to promote the drying of ink, the PC 1 suitably controls the printer 2 to discharge sheets in the discharge tray with the printed surfaces facing upward in the order “page 6, page 5, . . . , page 2, page 1.”

When the user has selected duplex printing in the duplex printing selection field 53A of the print settings screen D2, sheets printed by the printing unit are discharged into the discharge tray so that the surfaces for page 2, page 4, and page 6 are facing upward and are discharged in that order.

Since printers that perform printing according to the inkjet method preferably discharge sheets with the printed surfaces facing upward to promote the drying of ink, the PC 1 of the present embodiment suitably controls the printer 2 to discharge sheets so that the surfaces printed second, i.e., page 2, page 4, and page 6, face upward and are discharged in that order into the discharge tray.

When the print settings indicate that duplex printing is not to be performed in the present embodiment, the auxiliary program 42 notifies the general-purpose printing program 41 to enable a setting for printing in reverse page order. Accordingly, the general-purpose printing program 41 generates intermediate data in reverse page order, and the auxiliary program 42 acquires this intermediate data arranged in reverse page order from the general-purpose printing program 41. Hence, the auxiliary program 42 can control the printer 2 to print pages in their reverse order without having to rearrange (reorder) the printing order itself.

### Second Embodiment

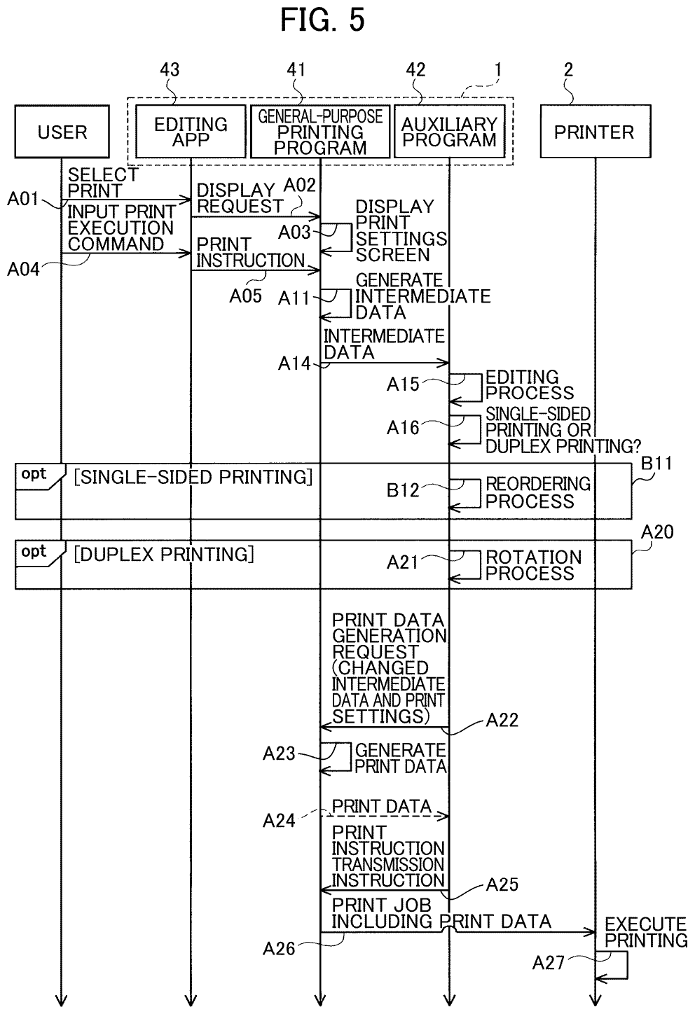

Next, steps in a printing process according to a second embodiment when printing is executed using the printer 2 will be described with reference to the sequence chart illustrated in FIG. 5. All processes other than user operations in this embodiment essentially indicate processes performed by the CPU 11 according to instructions described in the auxiliary program 42 and other programs. In the following description, steps that have the same effects as those in the first embodiment are designated with the same step numbers.

In the present second embodiment, the auxiliary program 42 does not issues a reverse-order output request to the general-purpose printing program 41 to output intermediate data in reverse order regardless of whether the print settings specify single-sided printing or duplex printing. Hence, the general-purpose printing program 41 passes the intermediate data, along with the print settings, to the auxiliary program 42 in the normal order, i.e., the processing order “page 1, page 2, . . . , page 5, page 6” defined by the page order of the intermediate data. In this respect, the second embodiment differs from the first embodiment in which the auxiliary program 42 issues a reverse-order output request to the general-purpose printing program 41 when single-sided printing is specified.

After acquiring intermediate data from the general-purpose printing program 41 in A14, in A16 the auxiliary program 42 according to the present embodiment determines whether single-sided printing or duplex printing is specified in the print settings.

When the auxiliary program 42 determines that single-sided printing is specified (option B11), in B12 the auxiliary program 42 performs a reordering process. For example, when the intermediate data is configured of six pages, as illustrated in FIG. 4A, the auxiliary program 42 rearranges (reorders) the processing order “page 1, page 2, . . . , page 5, page 6” defined by the page order of the intermediate data to “page 6, page 5, . . . , page 2, page 1” according to the printing order in the single-sheet conveying method described above.

On the other hand, when the auxiliary program 42 determines that duplex printing is specified (option A20), in A21 the auxiliary program 42 performs the rotation process described above without executing the reordering process. For example, when the intermediate data is configured of six pages, as illustrated in FIG. 4B, the auxiliary program 42 edits the intermediate data in the processing order “page 1, page 2, . . . , page 5, page 6” defined by the page order of the intermediate data to rotate the intermediate data for odd-numbered pages 180 degrees based on the printing order in the single-sheet conveying method described above. When consolidated printing such as 2-in-1 printing has been set, the auxiliary program 42 performs the reordering process of B12 or the rotation process of A21 for each new page following the editing process of A15.

Next, in A22 the auxiliary program 42 passes the print settings and intermediate data to the general-purpose printing program 41 and issues a request to the general-purpose printing program 41 to generate print data (print data generation request). The remaining process following A22 is identical to that in the first embodiment. The process of B12 is an example of the (c) controlling of the present disclosure.

By having the auxiliary program 42 reorder the pages being printed in the case of single-sided printing, the present embodiment increases printing flexibility by having the auxiliary program 42 set the printing order. Further, the auxiliary program 42 can easily change the printing order by reversing the order of pages in intermediate data acquired in the normal page order.

### Third Embodiment

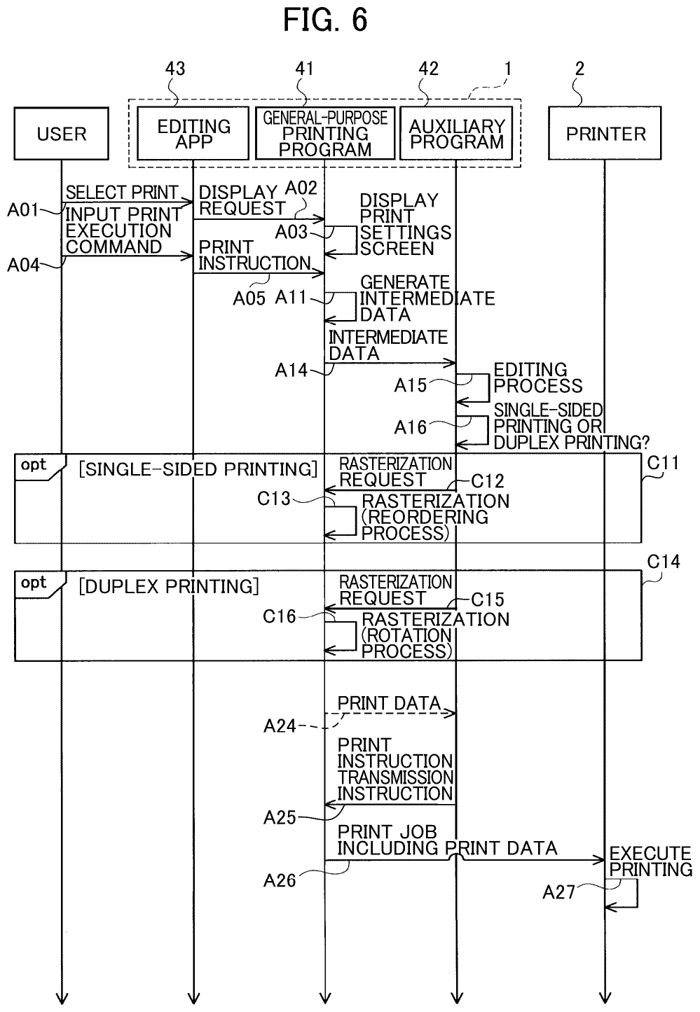

Next, steps in a printing process according to a third embodiment when printing is executed using the printer 2 will be described with reference to the sequence chart illustrated in FIG. 6. All processes other than user operations in this embodiment essentially indicate processes performed by the CPU 11 according to instructions described in the auxiliary program 42 and other programs. In the following description, steps that have the same effects as those in the first and second embodiments are designated with the same step numbers.

In the present third embodiment, the auxiliary program 42 does not perform reordering on the intermediate data, but the pages are rearranged (reordered) when the intermediate data is rasterized. In this respect, the third embodiment differs from the first and second embodiments in which the intermediate data is reordered. Similarly, in the present third embodiment, image rotation is not performed on intermediate data but is performed during rasterization. In the present third embodiment, the auxiliary program 42 does not issue a reverse-order output request to the general-purpose printing program 41, regardless of whether the print settings specify single-sided printing or duplex printing. Hence, as in the second embodiment, the general-purpose printing program 41 passes the intermediate data, along with the print settings, to the auxiliary program 42 in the normal order, i.e., the processing order “page 1, page 2, . . . , page 5, page 6” defined by the page order of the intermediate data.

After acquiring intermediate data from the general-purpose printing program 41 in A14, in A16 the auxiliary program 42 according to the present embodiment determines whether single-sided printing or duplex printing is specified in the print settings.

When the auxiliary program 42 determines that single-sided printing is specified (option C11), in C12 the auxiliary program 42 passes the intermediate data edited in A15 to the general-purpose printing program 41 and issues a request to the general-purpose printing program 41 to rasterize the intermediate data (rasterization request). At this time, the auxiliary program 42 requests the general-purpose printing program 41 to change (reorder) the processing order during rasterization from the order “page 1, page 2, . . . , page 5, page 6” defined by the page order of the intermediate data to the reverse order, i.e., the order “page 6, page 5, . . . , page 2, page 1” as illustrated in FIG. 4A. In C13 the general-purpose printing program 41 then rasterizes the intermediate data in the order of “page 6, page 5, . . . , page 2, page 1.” The process of C12 is an example of the (c) controlling of the present disclosure.

On the other hand, when the auxiliary program 42 determines that duplex printing is specified (option C14), in C15 the auxiliary program 42 passes the intermediate data edited in A15 to the general-purpose printing program 41 and issues a request to the general-purpose printing program 51 to rasterize the intermediate data (rasterization request). At this time, the auxiliary program 42 requests the general-purpose printing program 41 to rotate the intermediate data for odd-numbered pages 180 degrees during rasterizing the intermediate data in the processing order “page 1, page 2, . . . , page 5, page 6” defined by the page order of the intermediate data, as illustrated in FIG. 4B. The target of rotation may instead be intermediate data for the even-numbered pages, as illustrated in the example of FIG. 4C. Next, in C16 the general-purpose printing program 41 rasterizes the intermediate data in the processing order “page 1, page 2, . . . , page 5, page 6” defined by the page order of the intermediate data while rotating intermediate data for odd-numbered pages 180 degrees. Alternatively, the general-purpose printing program 41 may rasterize the intermediate data while rotating intermediate data for even-numbered pages 180 degrees.

After completing one of the options C11 and C14, in A24 the general-purpose printing program 41 passes the resulting print data to the auxiliary program 42. The remaining process following A24 is identical to that in the first embodiment.

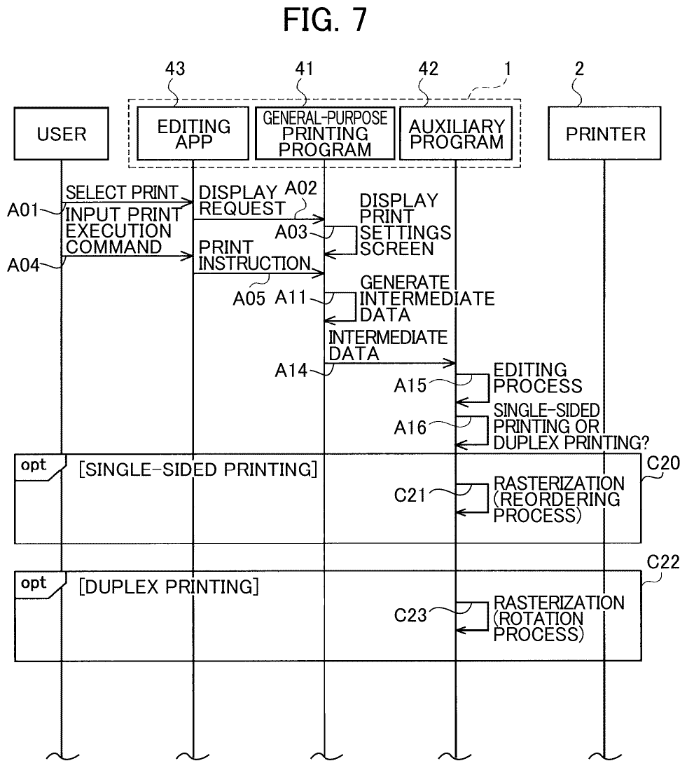

Note that the auxiliary program 42 may also perform the rasterization in place of the general-purpose printing program 41, as illustrated in the sequence chart of FIG. 7. In this case, when the auxiliary program 42 determines that single-sided printing is specified (option C20), in C21 the auxiliary program 42 rasterizes the intermediate data while changing (reordering) the processing order “page 1, page 2, . . . , page 5, page 6” defined by the page order of the intermediate data to the order “page 6, page 5, . . . , page 2, page 1” as illustrated in FIG. 4A. The process of C21 is an example of the (c) controlling of the present disclosure.

When the auxiliary program 42 determines that duplex printing is specified (option C22), in C23 the auxiliary program 42 rasterizes the intermediate data in the processing order “page 1, page 2, . . . , page 5, page 6” defined by the page order of the intermediate data while rotating intermediate data for odd-numbered pages 180 degrees, as illustrated in the example of FIG. 4B. Note that the target of rotation may instead be intermediate data for even-numbered pages, as illustrated in the example of FIG. 4C.

As described above in detail, the above embodiments describe processing for a printer 2 having a conveying mechanism that discharges sheets with the printed surfaces facing upward. When single-sided printing, rather than duplex printing, is specified, the printing order for print data to be transmitted to the printer 2 is set to the reverse page order so that the printer 2 outputs a set of printed matter into the discharge tray with pages arranged in order from top to bottom. This method eliminates the need for the user to rearrange the printed sheets and outputs printed matter in a manner that is less likely to stain the user's hands with colorant. When duplex printing is specified, on the other hand, both sides (surfaces) of the sheets are printed surfaces and neither side (surface) is given priority for the drying of colorant. Hence, the printing order for print data to be transmitted to the printer is kept in the normal page order, eliminating the process of reversing the page order, which will likely enable the printing process to begin sooner.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. For example, a device connected to the PC 1 is not limited to a printer, but may be any device having a printing function, such as a multifunction peripheral, copier machine, and facsimile machine. The number of devices connected to the PC 1 is not limited to that illustrated in the drawings, but may be two or more.

Furthermore, the screens displayed on the user interface 13 in this specification are merely examples and are not limited to the examples illustrated in the drawings. The wordings, shapes of objects, backgrounds, and the like depicted in these screens may be of any types. Furthermore, while FIG. 3 illustrates one example of a print settings screen D2 that includes a single information display area 52, the arrangement, shape, size, number, and the like of the information display areas 52 are not limited to this example. Alternatively, the information display area 52 may be eliminated.

Furthermore, the auxiliary program 42 may acquire raster data generated by the general-purpose printing program 41 or the auxiliary program 42 itself and may process this data as needed. For example, the auxiliary program 42 may generate print data by encoding the raster data as PDL data suitable for the printer 2. PDL is an abbreviation of Page Description Language. The PDL data generated by the auxiliary program 42 may be in a format that can be used for printing on printers other than the printer model of the printer 2.

While the general-purpose printing program 41 transmits a print job to the printer 2 in the above example, the auxiliary program 42 may instead transmit the print data to the printer 2 together with a print command instructing the printer 2 to execute printing. Furthermore, when the print settings include settings for an image process that can be executed on the printer 2, for example, the auxiliary program 42 may generate a print command that includes information on this process. In this case, the auxiliary program 42 may notify the general-purpose printing program 41 that the process has ended after the transmission of print data is complete.

In the above embodiments, the PC 1 is configured to reverse the page order and/or rotate pages depending on whether single-sided printing or duplex printing is selected in the duplex printing selection field 53A of the print settings screen D2, but the rotation process is not required. The PC 1 may switch whether rotation is required according to the capabilities and print settings of the printer 2. For example, the capability information acquired from the printer 2 may include information indicating whether the printer 2 can perform a rotation process, and the PC 1 may execute the rotation process when acquiring capability information indicating that the printer 2 cannot perform the rotation process. The PC 1 may also determine the need for rotation from settings specifying the page binding direction or opening direction, for example.

In the embodiments described above, only printing operations have been described in detail as the operations of the auxiliary program 42, but the auxiliary program 42 may have other roles. Furthermore, the program that executes the processes described in the embodiments is not limited to the auxiliary program 42 but may be another program that receives instructions from the OS 21 or the general-purpose printing program 41 when printing is performed using the general-purpose printing program 41. For example, a print workflow application program having specifications published by Microsoft Corporation may be used as the program.

The execution timing of the auxiliary program 42 is not limited to the examples in the embodiments. For example, the auxiliary program 42 may be executed in response to execution instructions received directly from the OS 21. Alternatively, the auxiliary program 42 may be a resident program, in which case the auxiliary program may perform the operations described above upon receiving an execution command.

In any of the sequence charts disclosed in the embodiments, the plurality of processes that make up any of the plurality of steps may be executed in parallel, or the order in which the processes are performed may be modified in any way that does not produce any inconsistencies in the processes.

The processes disclosed in the embodiments may be executed by a single CPU, a plurality of CPUs, an ASIC or other hardware, or a combination of these components. Furthermore, the processes disclosed in the embodiments may be achieved through a storage medium that stores the programs used to implement those processes or according to any of various other methods or formats.

What is claimed is:

1. A non-transitory computer-readable storage medium storing a support program for an information processing device communicable with a printer, an operating system of the information processing device including a general-purpose printing program, the support program corresponding to the printer and supporting the general-purpose printing program, the printer having: a single-sided printing function for performing single-sided printing; and a duplex printing function for performing duplex printing, the printer including a conveying mechanism configured to convey a sheet having a first surface and a second surface opposite the first surface, the conveying mechanism being configured to, when the printer performs the single-sided printing in which printing is performed on the first surface of the sheet, discharge the sheet with the first surface facing upward, the conveying mechanism being configured to, when the printer performs the duplex printing in which printing is first performed on the first surface of the sheet and subsequently performed on the second surface of the sheet, discharge the sheet with the first surface facing downward and the second surface facing upward, the support program, when executed by a computer of the information processing device, causing the information processing device to perform:
when a print instruction to have the printer execute printing of a target image for a printing target is issued from an application program implemented in the information processing device to the general-purpose printing program:
(a) acquiring intermediate data from the general-purpose printing program, the intermediate data representing the target image for the printing target corresponding to the print instruction; and
(b) executing a process for having the printer execute printing based on print data corresponding to the intermediate data acquired in the (a) acquiring,
wherein the support program, when executed by the computer, causes the information processing device to further perform, when the printing target corresponding to the print instruction includes a plurality of target images corresponding to respective ones of a plurality of pages:
(c) controlling a printing order of the plurality of target images for acquiring the print data to be transmitted to the printer, the (c) controlling including:
when a print setting corresponding to the print instruction includes a setting specifying the duplex printing, (c-1) setting the printing order for the print data to a normal order, the normal order being same as a page order in which the plurality of target images are arranged in the printing target; and
when the print setting corresponding to the print instruction does not include the setting specifying the duplex printing, (c-2) setting the printing order for the print data to a reverse order, the reverse order being opposite the normal order.

2. The non-transitory computer-readable storage medium according to claim 1,
wherein the (c) controlling includes:
when the print setting corresponding to the print instruction does not include the setting specifying the duplex printing, (c-3) executing a requesting process for causing the information processing device to acquire, in the (a) acquiring, the intermediate data representing the plurality of target images arranged in the reverse order from the general-purpose printing program.

3. The non-transitory computer-readable storage medium according to claim 2,
wherein the support program, when executed by the computer, causes the information processing device to further perform:
(d) displaying, through a user interface of the information processing device, a settings screen for accepting a print setting to be used for printing on the printer, the settings screen having a field for selecting a setting specifying whether to perform the duplex printing, and
wherein the (c-3) executing the requesting process is performed when the print setting includes a setting specifying not to perform the duplex printing.

4. The non-transitory computer-readable storage medium according to claim 1,
wherein when the printing target corresponding to the print instruction includes a plurality of target images corresponding to respective ones of a plurality of pages:
the (a) acquiring acquires the intermediate data representing the plurality of target images arranged in the normal order from the general-purpose printing program,
wherein the (c) controlling includes:
(c-4) generating the print data from the intermediate data acquired in the (a) acquiring,
wherein when the print setting corresponding to the print instruction includes the setting specifying the duplex printing, the (c-4) generating generates the print data in accordance with the printing order set in the (c-1) setting, and
wherein when the print setting corresponding to the print instruction does not include the setting specifying the duplex printing, the (c-4) generating generates the print data in accordance with the printing order set in the (c-2) setting.

5. The non-transitory computer-readable storage medium according to claim 1,
wherein the (c) controlling includes:
when the print setting corresponding to the print instruction does not include the setting specifying the duplex printing, (c-5) performing a reordering process on the intermediate data acquired in the (a) acquiring, the reordering process including reordering the plurality of target images in the printing target in the reverse order.

6. The non-transitory computer-readable storage medium according to claim 1,
wherein the support program, when executed by the computer, causes the information processing device to further perform, when the printing target corresponding to the print instruction includes a plurality of target images corresponding to respective ones of a plurality of pages and the print setting corresponding to the print instruction includes the setting specifying the duplex printing:
(e) performing a rotating process for acquiring the print data with a specific target image among the plurality of target images rotated 180 degrees, the specific target image being an image which requires rotation.

7. The non-transitory computer-readable storage medium according to claim 1,
wherein the (c) controlling includes:
when the print setting corresponding to the print instruction includes the setting specifying the duplex printing and the printer is configured to perform printing according to an inkjet method, (c-6) causing the printer to perform printing based on the print data acquired in accordance with the printing order set in the (c-1) setting; and
when the print setting corresponding to the print instruction does not include the setting specifying the duplex printing and the printer is configured to perform printing according to the inkjet method, (c-7) causing the printer to perform printing based on the print data acquired in accordance with the printing order set in the (c-2) setting.
